(19) United States
(12) Patent Application Publication
(10) Pub. No.: US 2024/0065926 A1
(43) Pub. Date: Feb. 29, 2024

(54) NECK TREATMENT SYSTEM

(71) Applicant: Scott Layne, Waipahu, HI (US)

(72) Inventor: Scott Layne, Waipahu, HI (US)

(21) Appl. No.: 17/900,564

(22) Filed: Aug. 31, 2022

(51) Int. Cl. A61H 11/00

(52) U.S. Cl. CPC A61H 11/00; A61H 2205/04

(57) ABSTRACT

A neck treatment system for a user comprises an elongated strap and having at least one handle at each end portion of the strap, with a hollow sleeve through which the strap extends without the handles being covered. There are two projections projecting from the outer surface of the sleeve for applying pressure at selected locations on the user's neck.

### BACKGROUND

Sore necks are unfortunately common. They can result from age, arthritis, and accidents, such as an automobile accident causing whiplash.

An exercise device for exercising the neck and spine of the user is described in Meyer U.S. Publication No. 2013/0053225.

It is desirable to have a more effective treatment system than that disclosed in the Meyer published application.

### SUMMARY

Accordingly, the present invention provides an effective neck treatment system for a user such as a patient undergoing physical therapy. A preferred system comprises an elongated strap at least 8 inches long and having opposed end portions. The system includes a hollow sleeve through which the strap extends. The sleeve has an outer surface. There is at least one handle on each end portion for gripping by user. The sleeve is shorter in length than the strap, preferably so the handles are not covered by the sleeve. There are two projections, although there can be more than two, projecting from the outer surface of the sleeve. The projections are laterally spaced from each other by about 0.2 to about 2 inches and project from the outer surface of the sleeve by about 0.5 to about 1.5 inches. The projections allow for treatment at selected portions of the neck, such as at or adjacent to the spinous process.

Typically, the projections are hemispherical. The sleeve can may be made of silicone.

In one version of the invention the sleeve are projections are unitary, i.e. of monocoque construction. Alternative the sleeve has openings with the projections being placeable through the openings.

Optionally, the strap has a longitudinal axis with each end portion of the strap having two handles spaced apart longitudinally from each other.

Preferably the projections are spaced apart from each other by about 0.25 to about 1.75 inches, and preferably the projections project from the outer surface by 0.5 to about 1.25 inches.

Optionally the system can be provided as a kit comprising a strap, a sleeve, and packaging for the strap and sleeve. In the version of the invention where the projections project through openings in the sleeve, the packaging contains the strap, the sleeve, and the projections.

An optional version of the invention does not include the sleeve, and the projections project from the strap.

For use of the system, the strap with the sleeve are placed on the user's neck with the projections projecting onto the user's neck. The user grips the handles, and then pulls on the handles for pulling the projections onto the user's neck.

### DRAWINGS

These and other features, aspects, and advantages of the present invention will become better understood with regard to the following description, appended claims, and accompanying drawings where:

FIG. 1 is a perspective view of a device in use, the device having features of the present invention, including a sleeve;

FIG. 2 is a side elevation view of the device of FIG. 1;

FIG. 2A is a side elevation view of the sleeve of the device of FIG. 1;

FIG. 3 is a top plan view of the device of FIG. 2;

FIG. 4 is a sectional view of the device of FIG. 1 taken on line 4-4 in FIG. 2;

FIG. 5 is a sectional view similar to that of FIG. 4 for a first alternate version of the present invention;

FIG. 6 is a perspective view of a projection for use with the device of FIG. 5;

FIG. 7 shows the device of FIG. 5 disassembled and in packaging;

FIG. 8 is a perspective view of a second alternate version of the present invention; and

FIG. 9 is a close-up perspective view of the device of FIG. 1 against a user's neck.

### DESCRIPTION

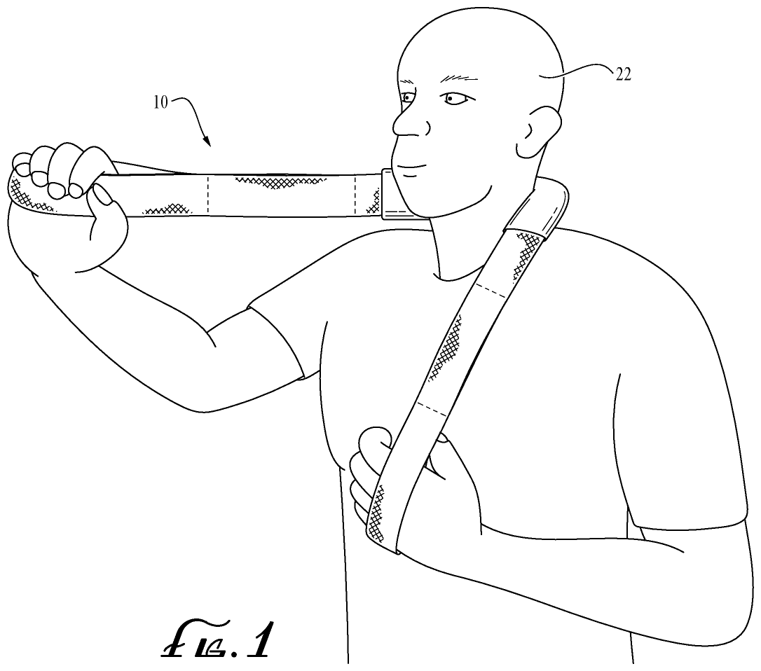

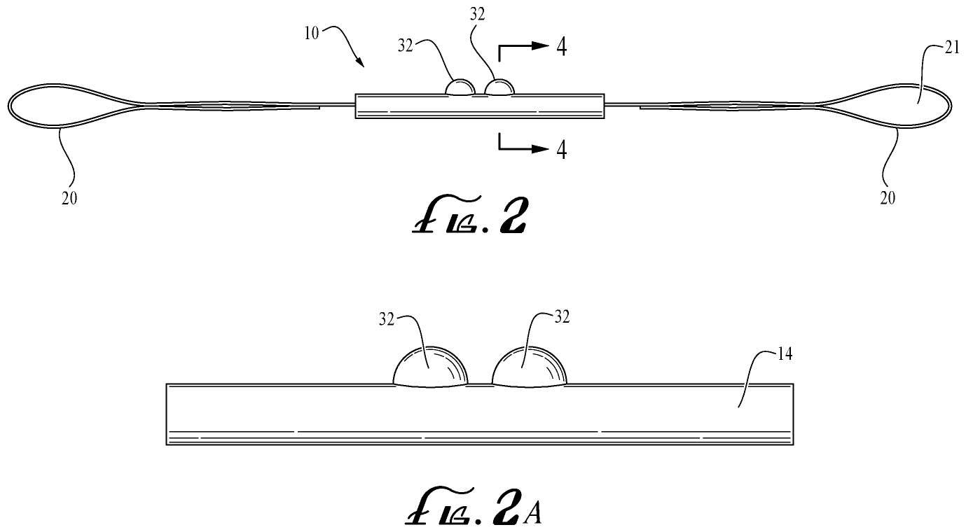

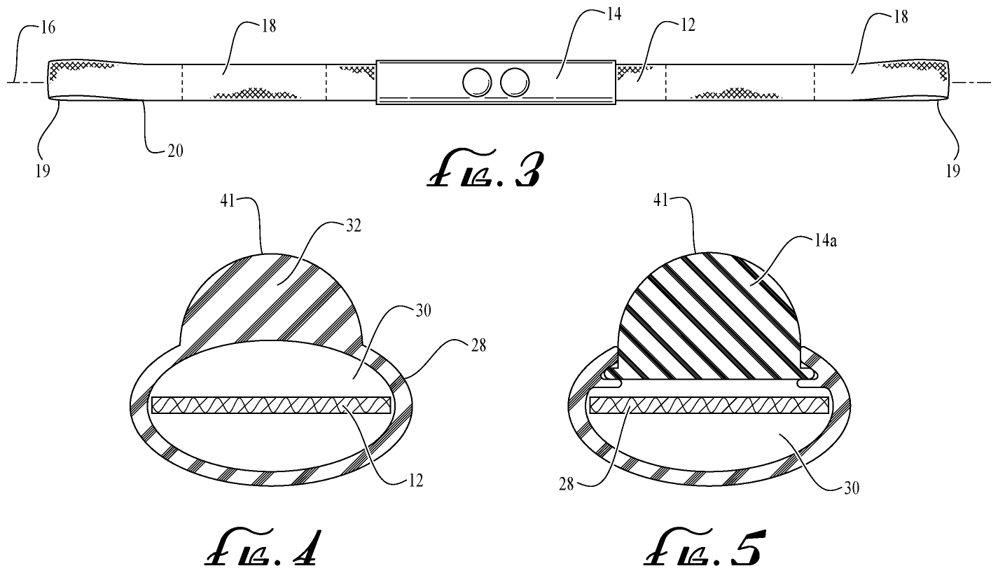

With reference to FIGS. 1-4 and 9, a system having features of the present invention includes a device 1 as its main components, a strap 12 and sleeve 14 over the strap 12.

The strap 12 has a longitudinal axis 16 and opposed end portions 18 with each end portion 18 having an end 19. Each end portion 18 has at least one handle 20, and optionally multiple handles, to accommodate users 22 of different sizes. As described below, the handles 20 are gripped by the user 22 for applying tension to the user's neck 24.

The strap 12 can be made of many different materials such as fabric, rubber, and plastic, and optionally can be stretchable or elastic such as exercise bands used with handles. The strap can be in a variety of shapes. As shown in the drawings the strap is square in cross-section, but it can be round or oblong in cross-section.

One of the handles 20 can be attached to each end 19 of the strap, or alternately the strap can be folded over and stitched at the opposed end portion 18 of the strap 12 to form one or more loops 21 at the end portions, each loop being sized to accommodate a user's hand.

The strap 12 is at least 8 inches long and can be up to 100 inches long, the length being chosen to accommodate different sized users.

The sleeve 14 has an outer surface 28 and a hollow center 30. so that the strap 12 can slide in the sleeve 14. Preferably the sleeve 14 can be made from plastic such as polyethylene or polypropylene, and preferably silicone, for comfort for the user and easy sliding of the strap 12 through the sleeve 14.

There are two projections 32 projecting from the other surface 28 of the sleeve 14. The projections 32 can be used for applying pressure to selected portions of the user's neck 24, such as on or adjacent to the spinous processes. There can be more than two projections. The projections are laterally spaced apart from each other by about 0.2 to about 2 inches, preferably by about 0.25 to about 1.75 inches. The projections 32 project from the outer surface 28 by about 0.25 to about 1.5 inches, and more preferably by about 0.5 to 1.25 inches.

Preferably the sleeve 14 with the projections 32 are of unitary, also known as monocoque, construction such as by producing the sleeve with the projections by injection molding.

Typically, the thickness of the sleeve wall 27 is about 1/32 to about ½ inch and preferably about 1/16 to about 2/16 inch.

A preferred material for the sleeve has shore A hardness of from about 40 to about 70.

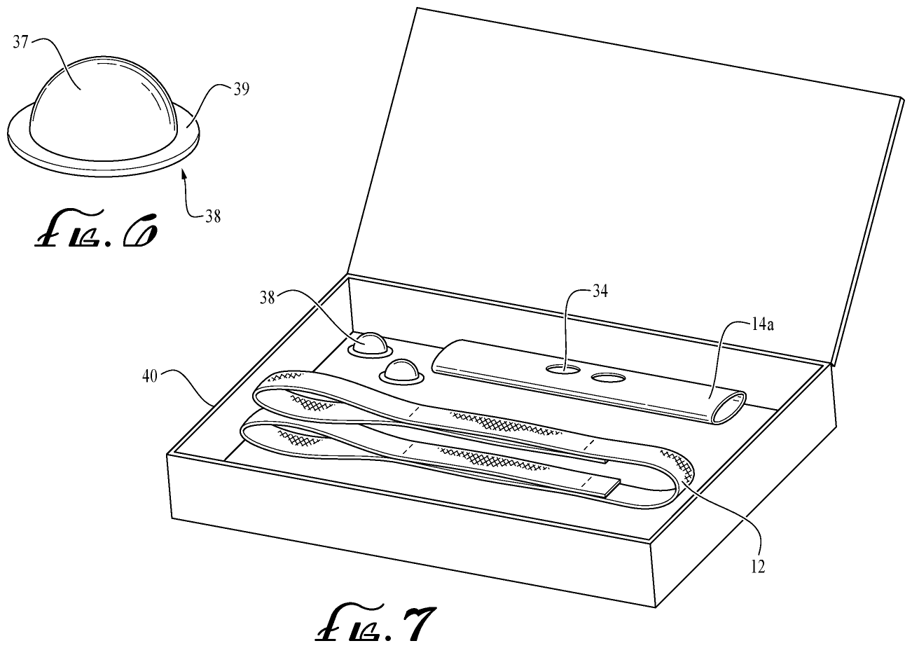

In a first alternate version of the invention as shown in FIGS. 5-7, rather than have the projections 32 and the sleeve 14 of unitary construction, a sleeve 14a can be provided with openings 34 with separate placeable projections 36 which can be placed through the openings 34. The separate projections 36 have a hemispherical body 37 with a base 38 having a rim 39, which can be segmented, where the diameter of the rim is 39 is larger than the diameter of the openings 34 so that the projections 36 are held in place while using the system shown in FIG. 5.

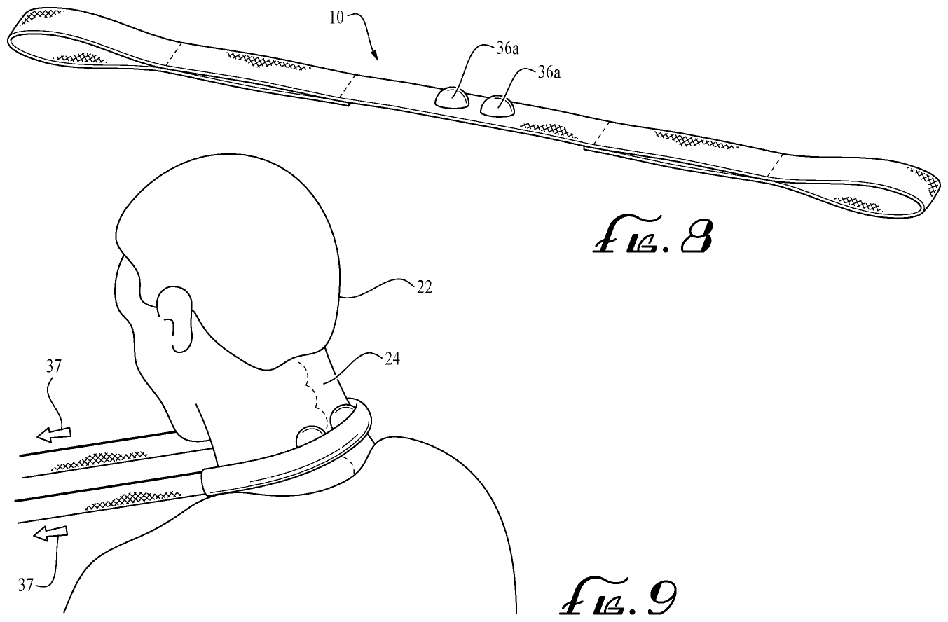

In a second alternative version of the invention as shown in FIG. 8, the sleeve is not included; rather the projections 36a are on the strap 12.

In use of the device as shown in FIGS. 1 and 9, the device is placed by a user's neck with each projection 36 projecting onto the user's neck on the side or the back of the neck. The user grips the strap by the handles, but optionally a second person such as a physical therapist, and pull she strap into the user's neck with the handles. The projections are pulled by the handles in the direction shown by arrows 37 onto a selected portion of the user's neck for treatment of the neck.

Typically, the projections are hemispherical in shape with the top 41 of the hemisphere extending away from the strap 12. The projections are substantially solid.

As shown in FIG. 7, the device can be provided packaged in packaging 40 with the strap and sleeve separate, to be assembled together by a user. In the version of the invention where the projections are not incorporated into the sleeve 14 as unitary construction, the projections can be provided separately in the packaging 40 as shown in FIG. 7.

Although the present invention is described in considerable detail with reference to certain preferred versions thereof, other versions are possible. Therefore the spirit and scope of the present invention should not be limited to the preferred versions thereof.

What is claimed is:

1. A neck treatment system for a user comprising:
a. an elongated strap at least 8 inches long and having opposed end portions;
b. at least one handle on each end portion for gripping by the user;
c. a hollow sleeve through which the strap extends with the handles not being covered by the sleeve, the sleeve having an outer surface; and
d. two projections projecting from the outer surface of the sleeve, the projections being laterally spaced apart from each other by about 0.2 to about 2 inches and projecting from the outer surface by about 0.5 to about 1.5 inches.

2. The system of claim 1 wherein the projections are hemispherical.

3. The system of claim 1 wherein the sleeve is made of silicone.

4. The system of claim 1 wherein the sleeve and projections are of monocoque construction.

5. The system of claim 1 wherein the projections are removable from the sleeve.

6. The system of claim 1 comprising two handles on each end portion.

7. A kit for treating the neck of a user comprising:
a. an elongated strap at least 8 inches long and having opposed end portions with a handle on each end portion for gripping by the user;
b. a hollow sleeve through which the strap can extend with the handles not being covered by the sleeve, the sleeve having an outer surface with two hemispherical projections projection from the sleeve, the projections being laterally spaced apart from each other by about 0.2 to about 2 inches and projecting from the outer surface by about 0.5 to about 1.5 inches.

8. The kit of claim 7 comprising packaging containing the strap and sleeve;

9. A kit for treating the neck of a user comprising:
a. an elongated strap at least 8 inches long and having opposed end portions with at least one handle on each end portion for gripping by the user;
b. a hollow sleeve through which the strap can extend with the handles not being covered by the sleeve, the sleeve having an outer surface with openings through the sleeve, the openings laterally spaced apart from each other by about 0.2 to about 2 inches; and
c. two hemispherical projections sized for pressing on the user's spinal processes, each projection being placeable for projecting through one of the openings.

10. The kit of claim 9 comprising packaging containing the strap, sleeve, and projections.

11. A method of treating a user's neck comprising the steps of:
a. selecting the system of claim 1;
b. placing the system on the user's neck with each projection projecting onto the user's neck;
c. gripping the handles; and
d. pulling on the handles for pressing the projections onto the user's neck.

12. The system of claim 1 wherein the projections are spaced apart from each other by about 0.25 to about 1.75 inches.

13. The system of claim 1 wherein the projections project from the outer surface by about 0.5 to about 1.25 inches.

14. A neck treatment system for a user comprising:
a. an elongated strap at least 8 inches long and having opposed end portions;
b. at least one handle on each end portion for gripping by a user;
c. a hollow silicone sleeve through which the strap extends with the handles not being covered by the sleeve, the sleeve having an outer surface and a wall, the wall being about 1/16 to about 2/16 inch thick; and
d. two solid silicone hemispherical projections projecting from the outer surface of the sleeves and sized for pressing on or proximate to the user's spinous processes, the projections being laterally spaced apart from each other by about 0.25 to about 1.75 inches and projecting from the outer surface by about 0.5 to about 1.5 inches.

15. The system of claim 1 wherein the strap has a longitudinal axis, and each end portion of the strap has two handles spaced apart longitudinally from each other.

16. A neck treatment system for a user comprising:
a. an elongated strap at least 8 inches long and having opposed end portions and an outer surface;
b. at least one handle on each end portion for gripping by a user; and
c. two projections projecting from the outer surface of the strap, the projections being laterally spaced apart from each other by about 0.2 to about 2 inches and projecting from the outer surface by about 0.5 to about 1.5 inches.
